(19) United States
(12) Patent Application Publication
(10) Pub. No.: US 2014/0201037 A1
(43) Pub. Date: Jul. 17, 2014

(54) SYSTEM AND METHOD FOR PURCHASING GOODS FOR DONATION TO CHARITIES

(71) Applicant: WAL-MART STORES, INC., Bentonville, AR (US)

(72) Inventors: Thushara Mallawarachchi, Bentonville, AR (US); Steve Menke, Rogers, AR (US); Britto Michaelsamy, Bentonville, AR (US); Sundararajan Periasamy, Bentonville, AR (US); Sudhakar Appala, Bentonville, AR (US)

(73) Assignee: WAL-MART STORES, INC., Bentonville, AR (US)

(21) Appl. No.: 13/740,546

(22) Filed: Jan. 14, 2013

(51) Int. Cl. G06Q 30/06

(52) U.S. Cl. CPC G06Q 30/0641
USPC 705/27.1

(57) ABSTRACT

A computerized method and system for online purchase and donation of goods includes: registering a charity and a shopper into a database; populating the database with a prioritized list of goods available in a retail store for purchase and donation to the charity; enabling the shopper to select and purchase goods on a computerized system for donation to the charity; and enabling transfer of the purchased goods from the store to the charity.

### FIELD OF THE INVENTION

The present invention relates generally to a system and method for purchase and donation of goods from a retail store to a charitable organization, also referred to as a charity. More specifically, the present invention relates to a system and method for enabling individuals, companies or organizations to enact on-line or in-store purchases of goods to be donated to a charity of their choice.

### BACKGROUND

Americans are generous in giving money and gifts each year to charitable organizations, and the majority of the contributions are donated by individuals and households. Often, individuals will purchase goods and bring them to the charitable organization that they wish to help. For instance, a church may have a canned food drive requesting the donation of canned foods for the needy. People will either empty their cupboards to donate canned items, or they will purchase canned goods at a store and then drop them off at the church or at a designated drop off location. Similarly, people will donate old or new clothing in special drop off bins for organizations such as the Salvation Army™.

There continues to be a compelling desire for people to help others in need and especially for people to select a charity of their choice to which to donate specific goods in a manner which is efficient and time saving to both the donor and the charity.

### BRIEF SUMMARY OF EMBODIMENTS

A computer-implemented method for purchase and donation of charitable goods includes the steps of: registering a charity into a database, and creating a charity profile with an unique charity ID; populating the database with a prioritized list of goods available in a retail store for purchase and donation to the charity; registering a shopper into the database, creating a shopper profile with an unique shopper ID; enabling the shopper to select a charity for donation, a store for purchase of goods, and goods for purchase and donation to the charity; and enabling the purchased goods to be transferred from the store to the charity as a donation.

A computer program product can be used to provide charitable giving through an online website. The computer program product can include, but is not limited to, a computer readable storage medium such as a flash drive, flash card, compact disk, DVD, portable disk drive, etc. having computer readable program code embodied thereon. The computer readable program code includes: (1) code configured to register one or more charities into a computer database, and create a charity profile and provide an unique charity ID for each of the charities; (2) code configured to populate the database with a prioritized list of charitable goods available in a store for purchase and donation to each of the registered charities; (3) code configured to register a philanthropic shopper into the database, create a shopper profile and provide an unique shopper ID; (4) code configured to enable the registered shopper to select one or more of the registered charities for donation using a graphical selection interface; (5) code configured to enable the registered shopper to select and purchase charitable goods on the list for donation to the selected one or more charities using the graphical selection interface; and (6) code configured to enable transfer of the purchased goods from the store to the charity.

A computer based system for enabling the purchase and donation of charitable goods includes: a first input device for registering a charity for donations from a store, wherein the store provides a master list of goods available for donation from the store and the charity selects needed goods from those available from the store; a second input device such as a graphical selection interface for registering a shopper who can thereafter logon to a charitable giving web site to purchase and donate goods from the store to the charity, so that the donated goods are picked up at the store by the charity; and a server including a processing unit for processing charity and shopper registration data received from the first and second input devices, and a database for storing the processed data including a master list of goods available for donation from the store and a needs list of goods needed by the charity, wherein the system enables a transaction via a network communication between the store, the shopper and the charity for the shopper to purchase goods using a graphical selection interface from the needs list of the charity available at the store, and to donate and facilitate the transfer of the purchased goods from the store to the charity.

The above and other aspects of various embodiments of the present invention will become apparent in view of the following description, claims and drawings.

### BRIEF DESCRIPTION OF THE SEVERAL VIEWS OF THE DRAWINGS

The accompanying drawings, in which like numerals indicate like structural elements and features in various figures, are not necessarily drawn to scale, the emphasis instead being placed upon illustrating the principles of the invention.

FIG. 1 is a graphical representation of a well known communications network;

FIG. 2 is a flow chart diagram of a method according to the invention for registration of a charitable organization into a computer system for providing donations from a store to the charity;

FIG. 3 is a flow chart diagram of a method according to the invention for management of a charity profile used in a computer system for providing donations from a store to a charity; and

FIG. 4 is a flow chart diagram of a method according to the invention for registration of a philanthropic shopper into a computer system for providing donations from a store to a charity.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

A retail store, outlet or chain of stores that wishes to aid the local community by assisting local charitable organizations may do so by encouraging philanthropic shoppers to donate goods purchased at the store to the charity of their choice. This laudable goal can be accomplished using a state of the art computer system and method of communications linking the shopper, the store and the charity via the Internet or any other communications network.

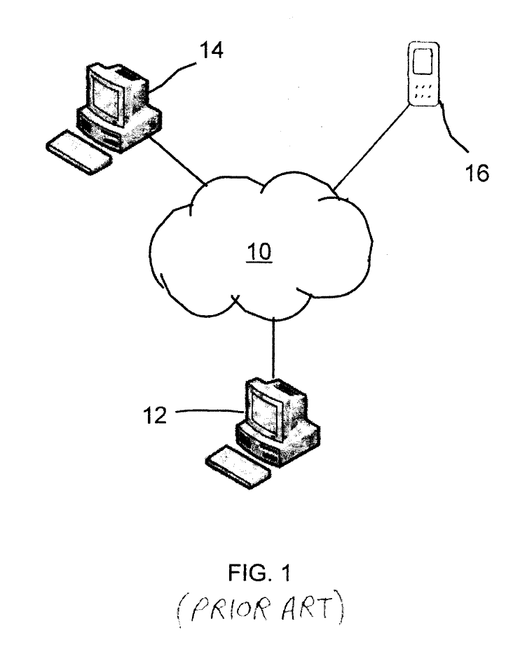

FIG. 1 is a graphical diagram of a well known communications system including a network such as an Internet 10 which links together computers and servers 12 and 14 either through hard wired circuits as shown or via wireless communications. Other communications devices such as a smart phone 16 having wireless internet access, a desktop computer, a laptop computer, tablet, and any other mobile or stationary communications device can be connected to the Internet 10.

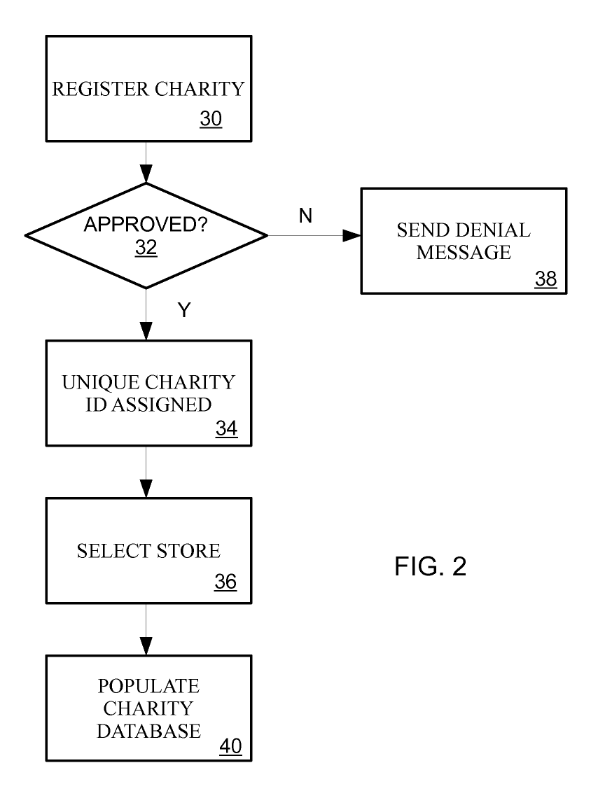

FIG. 2 is a flow chart diagram of a method for registering a charitable organization into the online charitable giving system. In step 30 a charity, particularly a nonprofit organization (NPO), will register with a retail store or chain of stores preferably by connecting online to a charitable giving portal of the retail store's website to create its unique giving registry (hereinafter also referred to as a “need list” or “charity database”). A store system administrator will manage and maintain the online giving system, which runs on a computer system or server, and includes information about the store and available products.

Registration by the charity includes creating a charity profile via a graphical interface to include information about the charity such as, but not limited to, the name and taxable status of the organization, the mailing and physical addresses, phone number, email address, contact representative, tax identification numbers, etc. After a registration form is submitted by a representative of the charity, a decision will be made whether to approve the registration of the charity in decision block 32. Approval can be subject to store policies, whether goods sought by the charity are available at the store, the charity's non-profit tax status, the location of the charity, whether the charity can pick-up donated goods from the store, whether the registration application is complete, etc.

If the charity registration request is denied in step 38, a message is sent back to the charity to indicate denial of registration. If the charity registration is approved by the store, the charity is assigned an unique charity identification number (i.e. charity registration ID) in step 34 as well as a password which is necessary for login authentication for all transactions and communications through the store charitable giving portal website.

The charity creates its charitable giving registry which is stored in a database linked to it's profile in the store's server or central computer system that can be located at the store or elsewhere. The charitable giving registry is available for displaying specific needed goods in keeping with the goals of the given charity. For instance, a charity food bank may be looking for donation only of food goods. Another charity may be looking specifically for clothing, etc.

In order to fulfill the need for specific goods by the given charity, that organization can create it's charitable giving registry via the graphical interface by either (1) providing a list of all goods needed to the store, or (2) selecting goods listed as available at the store. In either case, the goal is to match the list of goods that are readily available at the retail store with the list of needed goods for the given charity.

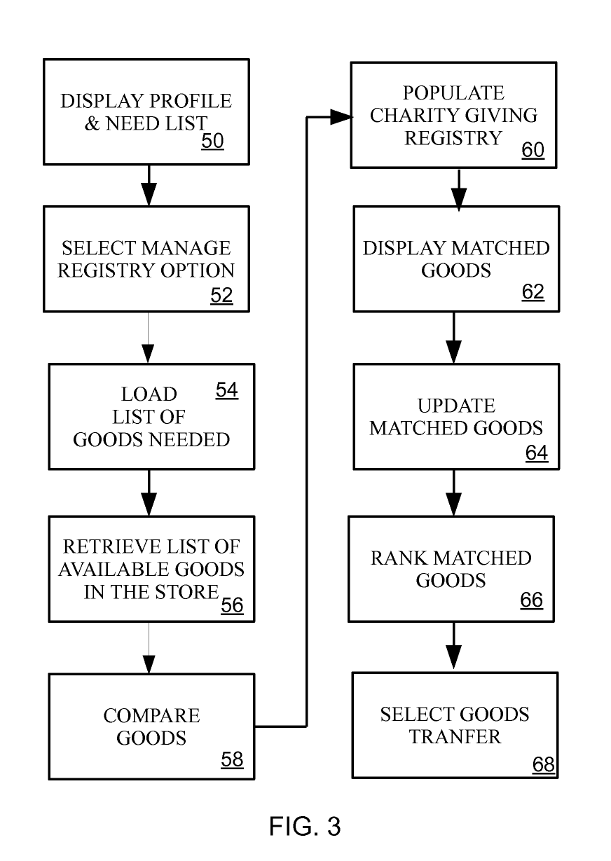

Once the charity is registered, it can manage its registry status for instance by selecting via the graphical interface one or more stores in step 36 for donations when the retail store has multiple locations, and by populating the charity database in step 40 according to items needed and items available at the store. Managing the charitable organization's registry items can be accomplished as outlined by the steps of FIG. 3 described below.

After registration and acceptance of the charity by the store, the charity representative can logon at any time to update the charity's profile and giving registry on the charity giving portal of the store website. After log in, a profile and need list (i.e. giving registry) for the charity is displayed in step 50. If it is desired to modify the profile including the need list, then a selection is made by the user in step 52 to manage the registry. The user can load a list of goods needed by the charity in step 54. This can be a new list, an update, or an addition of goods for the charity's giving registry. Along with adding goods to the list, the charity can delete goods which are no longer needed by the charity.

In step 56 the master list of goods available for charitable donation in the selected store is displayed. The user can populate the charity's giving registry in step 60 by manually matching goods needed to goods available at the store in step 58, or by automatically comparing goods via software, whereby the automatic comparison and matching of names, descriptions or other identifying criteria of the goods is provided. The matched goods are displayed in step 62 and the charity's giving registry is updated in step 64. This database can be changed at any time and most likely will be changed throughout different seasons of the year due to different seasonal needs by the charity and different goods available at the store.

After the charity's giving registry is populated and complete, the goods can be prioritized or ranked in step 66 so that the most needed goods will appear at the top of the list for that charity. In other words if there is a great need for children's winter jackets, then that item would appear high on the priority list and if there was a lesser need for men's suits, then that item would appear lower on the list. Of course, goods can alternately be prioritized as they are individually added to the list of needed goods.

As an alternative to uploading a list of needed goods, a master list of goods that are available at the selected store(s) can be viewed by the charity representative who can then select goods and quantities from the master list to create the need list for the charity.

After the charity database is populated and the goods are ranked, the user can use a graphical selection interface to select in step 68 a manner in which to transfer the donated goods from the store to the charity. Typically the charity will make arrangements to pick up the donated goods at the store but in some cases arrangements can be made for shipping the goods from the store to the charity. The charity could for instance have a specific day and time for picking up goods each week, or they could wait until notification from the store that a sufficient quantity of goods has been accumulated. Also, the charity can wait until notification that a case of canned food goods is available for pick up rather than picking up just a few cans at a time.

In order to participate in the purchase and donation of goods, a shopper must first register into the service. Any person, group, company or organization (hereinafter referred to as a “philanthropic shopper” or a “shopper”) can also register on the charitable giving portal of the retail store's website to participate in the charitable giving opportunities offered by the store jointly with the participating charities.

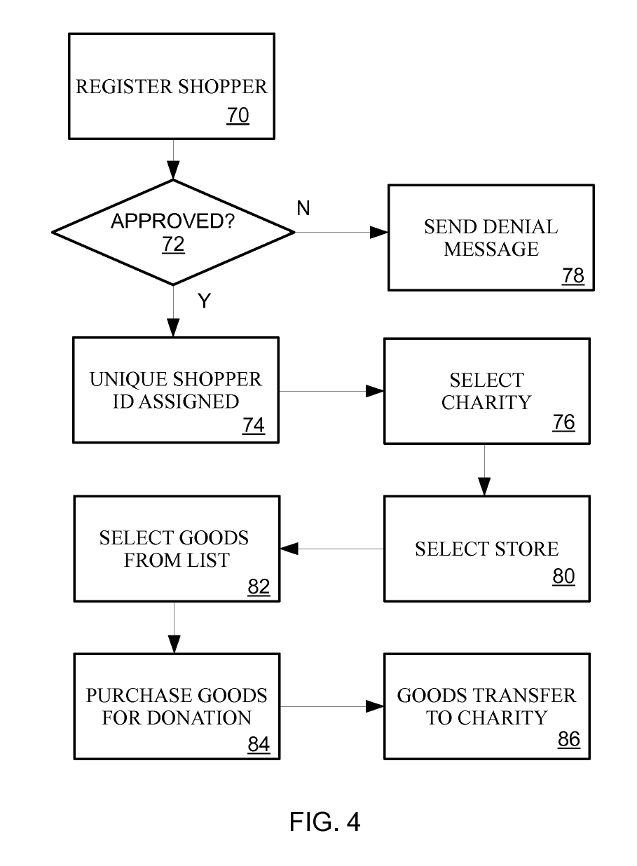

FIG. 4 is a flowchart of a preferred shopper registration method. Registration occurs online in step 70 where a philanthropic shopper will create a shopper profile via a graphical user selection interface including information such as, but not limited to, his/her name or business name, mailing and billing addresses, phone number, email address, tax identification numbers, a credit card for billing, etc. After registration is completed and approved by the store in step 72, the shopper will be provided with an unique shopper identification number (ID) and password in step 74 for access into the store's charitable giving website portal. If the registration is incomplete or the shopper is denied registration by the store for any reason, such as poor credit rating, previous returned checks for non-payment, etc., a denial of registration message will be sent to the shopper's email in step 78.

A registered shopper can decide to purchase and donate goods in several different ways. The shopper can go online and login to the store charitable giving website, then choose one or more charities in step 76 from a list of all available registered charities to which to donate goods. The shopper can save a preferred charity for future donations into his/her profile. The shopper can also select a specific store in step 80, which can be included in the shopper's profile, from a list of participating stores from which to make his or her purchase and donation.

In step 82 the shopper can select goods via the graphical selection interface from the charity's registry giving list for purchase and donation. Further, the shopper can save a list of specific items or types of items, such as toys, clothing, etc., as preferences for giving to the selected charity in his/her profile. Then whenever the shopper logs into his account, those selected items preferred by the shopper and needed by the selected charity will be prominently displayed.

The shopper in step 82 can select via the graphical selection interface a specific item for purchase and donation by viewing a list of goods needed by the selected charity which are available in the store. The listed item can also include the price, a description of the item, the number of items available in the store, a photo, current availability or back order status if not currently in stock, etc. An estimated delivery time to the charity can also be provided and shown to the shopper.

Once the shopper has selected a charity, one or more items, and a number of each of the items for purchase and donation, then the shopper can finalize the sale by selecting via the graphical selection interface a purchase icon on his/her computer device in step 84. A receipt which clearly states that the purchase was for donation of goods to a specific charity can be printed or emailed to the shopper for his/her records.

In addition to purchase data, information concerning the transfer, pick up or delivery of the purchased goods to the charity can be presented to the shopper. For instance prior to purchase of the goods, information can be provided to the shopper telling him/her when an expected pick up or delivery will occur. In this way, the shopper can be ensured that his donated goods will be received by the charity within a time frame acceptable to the shopper. The shopper may wish to have Christmas gift donations transferred to the charity no later than December 18th, or he may wish to have disaster relief goods transferred to the charity within a day or two.

After receipt of the charitable purchase, arrangements are made to transfer the goods to the charity in step 86. The store can notify the charity of the donation, schedule for the charity to pick up the donated goods at a local store, and prepare and package the purchased goods for pick up. Typically the charity can coordinate the pick up when a number of similar goods have been purchased for donation. For example if a shopper purchases canned vegetables for donation, then the pick up can be scheduled when a complete carton or case of the canned vegetables is filled to enable easier transfer of the goods. However, small or singular purchases of goods can also be picked up as coordinated between the store and the charity.

As an alternative to pick up by the charity, the donated goods can be shipped to the charity from the store. Also, the purchase of goods for donation is not limited to individuals. Companies, groups, etc. may also register on the charitable giving store website to purchase and donate goods for transfer from the store to the registered charity of their choice.

A philanthropic shopper or a charity can access the online charitable giving website using their home or office computers, desktop computers, laptop computers, mobile devices such as smart phones, tablets, and any other device which provides either wired or wireless access to the Internet or a similar network. Also, links to the charitable giving store website can be made available at the website for each charity and elsewhere on the web.

When a philanthropic shopper is shopping on the website, a display of their selected charity's top needs or top priority items is available in a web portlet from their preferred charitable organization's giving registry. Also, a display of specific goods as saved in the shopper's profile is available. The shopper can also access the full charity giving registry to see the complete need list for that given charity.

In addition to online purchase of goods for donation, a shopper can utilize the charitable giving system while physically shopping in the store. If the shopper sees an item that he/she would like to donate, the shopper can login to the charitable giving website on his/her mobile device such as a smart phone in the store and use a phone camera to scan the bar code of the item in the store. The smart phone can include a scanning application to directly scan the bar code of the item for purchase.

If the shopper does not have a smart phone available, then the shopper can physically pick up the item for purchase in the store and bring it to the cash register for purchase and donation. The store cash register employee can input the shopper ID and apply the item to the shopper's charitable purchase account. The item brought to the cash register can be prepared for delivery or pick up by the charity as previously described.

The store can maintain data for each of the purchased donated goods for each registered philanthropic shopper and for each registered charity. In that way a “Thank You” can be emailed or otherwise sent to each shopper for his purchase/donation.

Periodically throughout the year or at the end of the year, a statement can be prepared and sent via email to each shopper and charity which summarizes all the purchases for donation. The charity can receive a list of all donors and the items that they have donated throughout the year which can include cost, quantity and shipment summaries. The summaries can also be made available for shoppers and charities to view when they logon to the charitable contribution website in order to see the goods summaries for those specific shoppers and charities. Of course each shopper will only have access to his singular account and will not be able to view donations and purchases by others. Each summary can be an itemized list with totals for the number of goods donated, the costs of the goods, applicable taxes paid for the purchase of the goods, the names of the shoppers, the names of the applicable charitable organizations, etc.

The store can notify the Internal Revenue Service as well as state and local governments of the donations for charitable giving, the monies paid for tax deduction purposes, the identities of the donor philanthropic shoppers and the identities of the charitable organizations.

A system as illustrated in FIG. 1 can be implemented such as via an Internet or other network 10 for enabling purchase and donation of charitable goods. The system can include a first input device, such as a smart phone 16, computer, etc. for registering a charity for donations from a store. The store in turn can logon via a computer 12 to the charity giving website and provide a master list of goods available at the store for donation to specific charities. The charity can provide a needs list of needed goods matching goods available from the store. The system can include wireless communications.

A second input device such as a smart phone or computer can be used by a shopper to register for purchasing and donating goods purchased from the store to the charity of the shopper's choice. A server computer unit 14 is in communications with the first and second input devices, and the server includes a processing unit for processing charity and shopper registration data received from the first and second input devices. The server also maintains a database for storing the processed data including the master list of goods available for donation from the store and the needs list for donation to the charity. The complete system enables a transaction via an Internet network between the store, the shopper and the charity by providing graphical interfaces on a computer device (e.g. tablet, laptop, smart phone, desktop computer, etc.) that can be used by the store administrator, the shopper or the charity. The user graphical selection interface enables or facilitate the shopper to purchase goods from the needs list of the charity available at the store, and to donate and facilitate the transfer of the purchased goods from the store to the charity.

The system and method described herein can also be used to expedite charitable donations in times of great need and urgency such as after or during a disaster, e.g. hurricane, flooding, earthquake, tsunami, fire, etc. In this way, people can urgently help others in need very quickly over the Internet by purchasing and transferring goods of their choice to their designated charities.

Philanthropic shoppers also have the ability to add the link of their preferred charitable organization's charitable giving registry into social networks such as Facebook. This will enable the shoppers to promote and help their preferred charity with their family and friends.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. For instance, the order of actions during registration and maintenance by the shopper or the charity can vary without effecting the final results of providing goods for purchase and donation to selected charitable organizations. Such modifications and variations that may be apparent to a person skilled in the art are intended to be included within the scope of this invention as defined by the accompanying claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A computer-implemented method for purchase and donation of charitable goods, the method comprising:
registering one or more charities into a database, and creating a charity profile and providing an unique charity ID for each of the charities;
populating the database with a prioritized list of charitable goods available in a retail store for purchase and donation to each of the registered charities;
registering a philanthropic shopper into the database, creating a shopper profile and providing an unique shopper ID; and
providing a graphical selection interface for the registered shopper to (1) select one or more of the registered charities for donation, and to (2) select and purchase charitable goods on the list for donation to the selected one or more charities.

2. The computer-implemented method of claim 1, further comprising facilitating the registered shopper to select and purchase charitable goods on-line or in-store.

3. The computer-implemented method of claim 2, wherein the on-line purchase is implemented via a mobile application or via a desktop application.

4. The computer-implemented method of claim 2, wherein the in-store purchase comprises scanning a bar code on the charitable goods to be purchased, or taking a photograph of the bar code on the charitable goods to be purchased.

5. The computer-implemented method of claim 1, further comprising providing data of the purchase and donation to the store for accumulating the purchased goods into shipping containers and notifying the charitable organization when the purchased goods are available for pick-up at the store.

6. The computer-implemented method of claim 1, wherein each of the charities populates the database with a separate prioritized list of the charitable goods available in the store for purchase and donation to the given charity.

7. The computer-implemented method of claim 1, wherein the store provides each of the charities with a master list of goods available in the store for charitable giving, each charity populating the database with the list of the charitable goods needed, and each charity prioritizing the needed goods on the list.

8. The computer-implemented method of claim 1, wherein total costs and numbers of purchased goods for a given registered charity are stored under the unique charity ID for reporting to tax authorities.

9. The computer-implemented method of claim 1, wherein total costs and numbers of purchased goods by a given registered shopper are stored under the unique shopper ID for reporting to tax authorities.

10. The computer-implemented method of claim 1, wherein the store includes multiple locations, and further comprising providing a graphical selection interface for the registered shopper to select one of the multiple store locations for donation to the selected registered charities.

11. The computer-implemented method of claim 1, wherein the store includes multiple locations, and further comprising providing a graphical selection interface for the registered charity to select one of the multiple store locations for donations.

12. A computer program product, comprising:
a computer readable storage medium having computer readable program code embodied therewith, the computer readable program code comprising:
computer readable program code configured to facilitate one or more charities to register into a computer database and to create a charity profile with an unique charity ID for each of the charities;
computer readable program code configured to facilitate a system administrator to populate the database with a prioritized list of charitable goods available in a store for purchase and donation to the registered charities;
computer readable program code configured to facilitate a philanthropic shopper to register into the database and create a shopper profile with an unique shopper ID;
computer readable program code configured to facilitate the registered shopper to select one or more of the registered charities for donation using a graphical selection interface;
computer readable program code configured to facilitate the registered shopper to select and purchase charitable goods on the list for donation to the selected one or more charities using the graphical selection interface; and
computer readable program code configured to facilitate the registered shopper to select delivery data for transferring the purchased goods from the store to the charity.

13. The computer program product of claim 12 wherein the purchase by the shopper is implemented via a mobile application or via a desktop application.

14. The computer program product of claim 12 wherein the purchase can be provided from a smart phone scanning a bar code of the charitable goods to be purchased in the store, or from the smart phone taking a photograph of the bar code of the charitable goods to be purchased in the store.

15. The computer program product of claim 12 further comprising computer readable program code configured to facilitate each of the charities to populate the database with a separate prioritized list of the charitable goods available in the store for purchase and donation to the given charity.

16. The computer program product of claim 12 further comprising computer readable program code configured to provide each charity with a master list of goods available in the store for charitable giving, to allow each charity to populate the database with the list of the charitable needed goods, and to allow each charity to prioritize the needed goods on the list.

17. The computer program product of claim 12 further comprising computer readable program code configured to store and summarize total costs and numbers of purchased goods for each registered charity under the unique charity ID for reporting to tax authorities.

18. The computer program product of claim 12 further comprising computer readable program code configured to store and summarize total costs and numbers of purchased goods by the registered shopper under the unique shopper ID for reporting to tax authorities.

19. A system for facilitating purchase and donation of charitable goods, the system comprising:
a first input device for registering a charity for donations from a store, wherein the store provides a master list of goods available for donation from the store and the charity provides a needs list of needed goods matching goods available from the store;
a second input device for registering a shopper of the store, wherein the shopper views the needs list of the charity, and purchases goods from the needs list for donation to the charity, and the donated goods are picked up at the store by the charity; and
a server in communication with the first and second input devices, the server including a processing unit for processing charity and shopper registration data received from the first and second input devices, and a database for storing the processed data including the master list of goods available for donation from the store and the needs list for donation to the charity,
wherein the system facilitates a transaction via a network between the store, the shopper and the charity for the shopper to purchase goods via a graphical selection interface from the needs list of the charity available at the store, and to donate and select delivery data for transferring the purchased goods from the store to the charity.

20. The system of claim 19 for facilitating purchase and donation of charitable goods, wherein the first input device is one of a smart phone, a laptop computer, a desktop computer, a tablet and a mobile communications device.

21. The system of claim 19 for facilitating purchase and donation of charitable goods, wherein the second input device is one of a smart phone, a laptop computer, a desktop computer, a tablet and a mobile communications device.
